(19) United States
(12) Patent Application Publication
(10) Pub. No.: US 2016/0358406 A1
(43) Pub. Date: Dec. 8, 2016

(54) METHOD AND PROGRAM PRODUCT FOR SPORTS BETTING

(71) Applicant: Ian Michael Daly, Brisbane (AU)

(72) Inventor: Ian Michael Daly, Brisbane (AU)

(21) Appl. No.: 14/729,421

(22) Filed: Jun. 3, 2015

(51) Int. Cl. G07F 17/32; G06F 3/0481

(52) U.S. Cl. CPC G07F 17/32; G07F 17/3288; G07F 17/3211; G07F 17/3272; G06F 3/04815

(57) ABSTRACT

A method and program product comprise communicating with a computing system. The computing system being configured to present a sports game and accept wagers on events. A selection of the sports game is communicated to the computing system. A play of the sports game is received. An overlay is received. The overlay comprises a grid structure. The grid structure comprises a plurality of locations arranged in at least a two-dimensional space. The space at least overlaying a playing area of the sports game, wherein a single position on the overlaid playing area is identified by a one of the plurality of locations. A user's wager is communicated to the computing system. The wager at least comprises an event and a one of the plurality of locations for occurrence of the event. An outcome of the wager is received from the computing system.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

The present invention generally relates to online sports betting. More particularly, one or more embodiments of the invention generally relate to placing bets on the “Where” of a sporting occurrence during a sporting event. This then opens the opportunity to place a multiplicity of bets that include the “Where” in conjunction with bets on the “What”, “Who”, “When”, “Why” and “How” of an event occurring.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

By way of educational background, another aspect of the prior art generally useful to be aware of is that, the art presupposes a method for playing a sports game, and a gaming device. In another aspect of the prior art, a display illustrates different divided sections of a playing field, whereby the perimeter of the field represents a roulette wheel. At the start of the game, a player may place wagers in one or more sections expecting where the ball would be at the end of the play. Within each section is a number indicating the return of a wager should the play result in the ball being in any of those sections. Thus, for example, should the team with the ball advance to the “20” yard line; then the ball would be in the section of “0-28” and if a one unit wager had been placed for the ball to be in that section, then the return for that wager would be 25 units. Similarly, if the team having possession of the ball advances the ball to the extreme left to achieve a touchdown or TD, the return on a one unit wager would be 42 units. Thus, if the team having possession were to advance the ball to the 35 yard line, then players having wagered in the sections labeled “35 & 36” would be the winner, with a return of 30 units for each unit wagered. Once play has entered a section and settlement of the wager occurs, play resumes, with the potential payout from the sections being different from previous payout, since the play would commence from that starting point. Thus, as play occurs and changes on the field, new data, such as location of the ball or the play, is supplied to the server, and new odds are calculated. These odds, which are translated into payouts, are supplied to the apparatus through the Internet. In addition, while players may be playing the game on the apparatus, they may also be watching on a broadcast medium, such as over-the-air transmission, or cable or satellite, simultaneously with the actual play of the sports game on the physical field. In this manner, the enjoyment of watching the actual game is coupled with the anticipation of the “prediction” of the events of the sports game, as evidenced by the wager on the apparatus.

By way of educational background, another aspect of the prior art generally useful to be aware of is that, the art focuses on a method and apparatus for wagering on event outcomes of a game. A portion of a display may further comprise wagering opportunities on an event of the EPWG (golf game 400). A portion of the EPWG may comprise a golfer located at a tee on Hole 1 of a golf course. The golfer may drive a golf ball in a number of directions. The outcome of where the golf ball lands may represent a wagering opportunity. The outcome of where the golf ball lands after a competitor swings a club is an example of an event where a wagering opportunity may be offered to a player of an EPWG (the golf game 400).

In another aspect of the prior art, an outcome on a club selection by a competitor may be another wagering opportunity that may be offered to a player of the EPWG. In yet another aspect of the prior art, each direction may be labeled with indicia such as text, numbers, icons, color codes and the like on the display of the gaming machine. These indicia may provide for facile reference to a wagering opportunity by a player of the EPWG. In one embodiment of a wagering opportunity offered to a player, examples of indicia may include: A(3:1), B(5:1), C(2:1), D(1:) and the like. To better understand the meaning of these example indicia: A(3:1) may be a 3 to 1 wager that the competitor will land in a sand trap; B(5:1) may be a 5 to 1 wager that the competitor will land in water; C(2:1) may be a 2 to 1 wager that the competitor will land 200-250 yards in the left rough; D(1:1) may be a 1 to 1 wager that the competitor will land 225-250 yards in the fairway, and so on. In one embodiment a player may be offered the opportunity to skip a wager and thereby move to another wagering opportunity of the ongoing EPWG.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1a and 1b illustrate detailed perspective views of an overlay grid, in accordance with an embodiment of the present invention;

FIG. 2 illustrates an exemplary method of placing and wagering bets, in accordance with an embodiment of the present invention;

FIG. 3 illustrates an exemplary method for placing and wagering bets, in accorance with an embodiment of the present invention;

FIG. 4 illustrates a block diagram depicting a conventional client/server communication system, in accordance with an embodiment of the present invention; and

FIG. 5 illustrates a block diagram depicting a conventional client/server communication system, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys. Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit “about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application. When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

The functionality and/or the features of a device may be alternatively embodied by one or more other devices which are not explicitly described as having such functionality/features. Thus, other embodiments of the present invention need not include the device itself.

The present invention will now be described in detail with reference to embodiments thereof as illustrated in the accompanying drawings.

Various forms of online sport betting on the “Where” of a sporting event, or any outcome of a plurality of events, may be provided by embodiments of the present invention. In one embodiment of the present invention, by temporarily freezing the screen and overlaying the field of play with a digital grid to instantaneously pinpoint the exact location of an event occurring, may provide an immediate payout based on the location of that event. Predetermined wagers on particular events occurring during play may be paid in real-time to the person betting on the game or events that take place during the game. Other embodiments may utilize a mobile app that imposes a grid over a “conceptual” field of play, rather than an actual live event on a TV that is then frozen. This may allow someone to quickly select one or more grid areas (by tapping the appropriate areas on the mobile device) to bet on one or more areas “Where” an event will occur, with the gambling operator capturing the “Where” and paying out, without the gambler confirming this visually. In many embodiments, online sports gambling websites may allow for bets to be placed on the “What” (an event), the “Who” (which player or result), and the “When” (the time of the event), as well as the actual spot of the “Where” (the place on the field of play where the event occurs), during a live match. Embodiments of the present invention may be sold or licensed to online gaming and gambling web site operators.

In some embodiments, online gambling sites may provide opportunities to place a bet on the Where (the place on the field where the event occurs), or any given number of bets on any given sport. The placing of bets may be accomplished by using software overlay technology and a grid, or plurality of grids, to allow multiplicities of users to wager bets on where at any given location in the field of play an event will take place. It should be appreciated by one skilled in the art that one or more grids may have various shapes and sizes for any given sport. The gambling website may define the events that they are willing to accept bets upon.

In some embodiments, the gambling website/operator may nominate one event (for example, without limitation, a goal) in one sport (for example, without limitation, a particular soccer game) using the superimposable grid and the ability to gamble on that one event. In addition, multiple nominations of a plurality of events in a multiplicity of sports or gaming venues may also be used with superimposable grid with the ability to gamble on a multitude of events in real-time.

For example, without limitation, in some embodiments bets may be placed on sporting or gaming events such as, but not limited to, soccer, rugby, American football, tennis, polo, basketball, golf, horse racing, Olympics events, or any other sport. High resolution betting may occur for any number of events that take place during any live game. High resolution betting may comprise, for example, without limitation, wagering a bet in football on “Where” a foul or fumble will occur during the any play of the game, or “Where” a specific horse will place in a race (by reference to how many lengths behind the winner or in which grid sector the horse is in when the winner passes the finishing post), or in golf wagering “Where” on the green, at a specific hole, a specific player will hit the ball. Users engaging in high resolution betting and wagering of events taking place in real-time may combine a multiplicity of bets on events that may take place at any specific grid location on a playing field.

In some embodiments, it is contemplated that the overlay network may also comprise virtual edge and overlay structures combined with a fabric to display any multiplicity of events in real-time while allowing any number of bets to be waged on any plurality of events by any number of users. The overlay structure may be a software-defined networking (SDN) architecture, or any other overlay network comprising virtual machines, virtual switching, and tunneling protocols to allow for real-time betting and wagering of events.

In some embodiments, online gambling websites may be the users of the present invention offering additions to its current offerings. There may also be the opportunity to create and enable a retail board product for gambling use in for example, without limitation, homes and offices replicating the present invention as a fun game in the world of virtual sports as played on mobile devices, PC's and TV's.

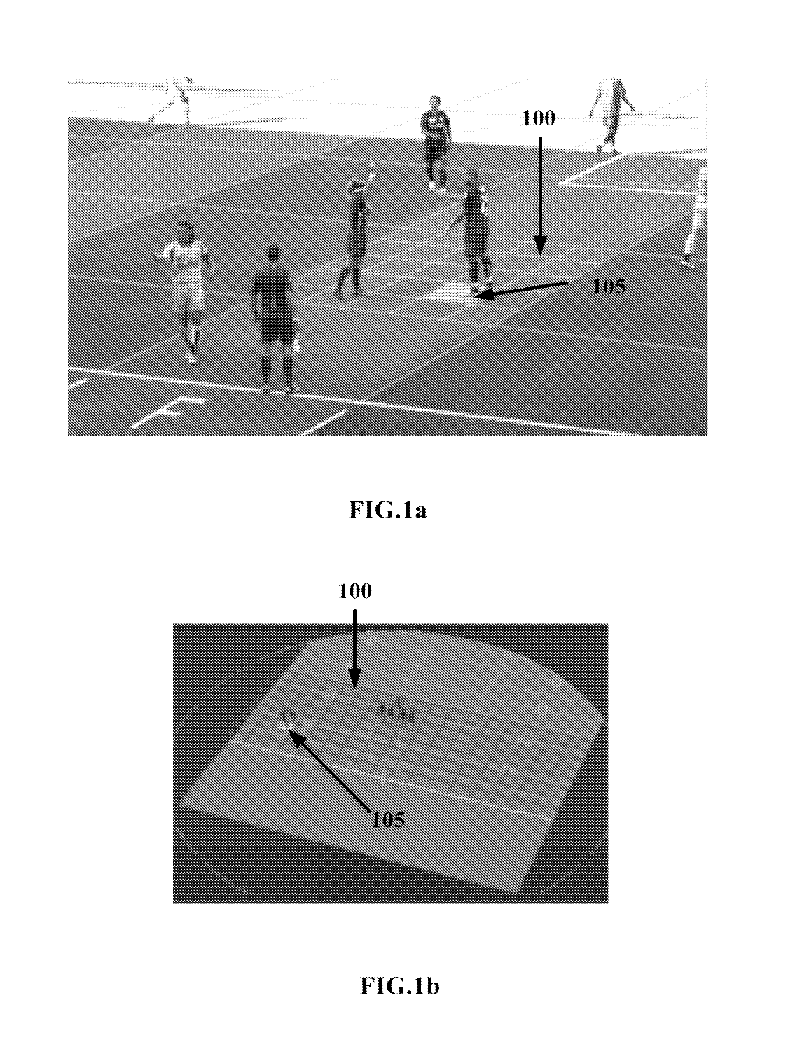

FIGS. 1a and 1b illustrate detailed perspective views of an overlay grid, in accordance with an embodiment of the present invention. A person betting may bet on the “Where” a specific action or result occurs within the overlay grid 100 in any real-time event, or live or internet based sporting game. A nomination by the person placing the bet of the “Where” in any event on the field of play may also be used in any real-time event, or live or internet based global sporting game. It is contemplated that the real-time images on the viewing screen may comprise a superimposable grid 105 to easily and accurately define the exact “Where” in any event a specific action or result will occur. The person using the graphical user interface (GUI) may select which superimposable grid 105 locations to place bets on as well as being able to place bets on a variety of different “Where” locations in any event continuously throughout the duration of either a live or internet based sporting game. In one embodiment, the platform may enable a variety of different odds to be placed based on the different “Where” locations in any event continuously throughout the duration of real-time event or gaming experience. It is contemplated, any reasonable number of combinations of the “Where”, “What”, “Who”, or the “When”, may be selected by the user to provide a variety of different odds and wagered amounts to be played in real-time.

The overlay grid 100 may comprise any plausible configuration or size of, for example, without limitation, circles, squares, hexagonal, or like parameters to identify the exact location anywhere in the field of play within a live event or within a computing game “Where” an event or action takes place. In a non-limiting example, the “Where” may occur in both vertical and horizontal planes within a field of play or surrounds (eg grandstands surrounding a field of play i.e. grid location of where a 6 is hit in cricket match).

In some embodiments, clearly and accurately identifying the exact location on the field of any event in a live sporting event or in a live gaming experience may provide the opportunity to place any multiplicity of bets in anticipation of “Where” an event will occur. In some embodiments, the opportunity to bet not only on the “Where” of an event, but also to have a combination of bets on the “Where”, “What”, “Who”, “When”, “How” and “Why” of an event occurring. The grid concept may then allow for a variety of different bets at a variety of different stages in various sporting events.

In another embodiment, other ways of betting may be implemented by which, for example, without limitation, an overlay grid may not be used for betting on the “Where” of an event, but rather any multiplicity of predetermined sets may be used to determine the “Where” of an event during a real time sporting event or online gaming experience. The GUI and overlay superimposable grid 105 may be implemented and transmittable over PC's, tablets, mobile phones, handheld devices, and TV's. In addition, the enabling technologies may assist in overlaying a grid (for example upon request by a user betting on a particular sporting event), then freezing of play in order to determine the result of the “Where” bet and then returning to the live sporting event. There may be a combination of viewing opportunities, for example, without limitation, viewing the ongoing sporting event in a GUI window whilst the frozen event is on the main frame of the TV/monitor or screen. In other embodiments, the live action may not be viewed at all by the person betting, rather they place bets on the grid.

In another embodiment, an overlay grid concept may be used in both vertical and horizontal applications, e.g. in addition to the horizontal surface of the field of play, the vertical surface, for example, without limitation, when a penalty kick is taken in soccer, to locate on the back or side of the goal and/or net “Where” the ball strikes, or “Where” a dart strikes on a dart board.

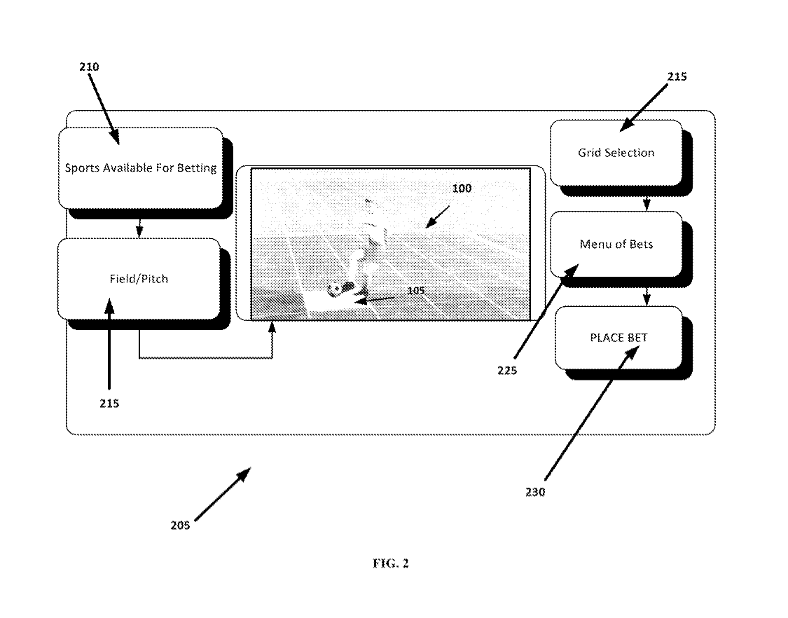

FIG. 2 illustrates a flow chart of an exemplary method of placing and wagering bets, in accordance with an embodiment of the present invention. A user of GUI may log on to a gambling website 205 and click on a sports available for betting 210. A user may then click on the icon a field of play/pitch 215 which may display an overlay grid 100 and a superimposable grid 105 options by which placement and type of grid a user would like for betting on the game being played is chosen, in a step grid selection 220 for your bet. The user may then go to a step menu of bets 225 and select, for example, without limitation, a red card, yellow card, goal, header, or tackle and then place your bet at a place bet 230. In some embodiments, various combination bets may also be accommodated to cover a mix of the “Where”, “Who”, “What”, “When”, “Why” and “How” of the same event. While it is contemplated that any number of practical betting combinations can exist within games of play, there also may exist other embodiments of betting and wagering that may be enabled through prediction wagering on events that may take place in the future based upon a user's analysis of the viewed game or event taking place in real-time. In some embodiments, user selections within GUI may have prediction wagering capabilities. In some applications, those skilled in the art may recognize and determine that betting on, and forecasting specific events entailing the “Where”, “Who”, “What”, “When”, “Why” and “How” may also be used for example, without limitation, in political election outcomes based upon real-time events occurring. In some alternate embodiments, upon selecting a bet, a betting odds may be displayed or overlaid on the selected grid location. In other alternate embodiments, betting odds may be displayed or overlaid in adjacent locations. In some other alternate embodiments, the user may select a location based on displayed/overlaid betting odds. In some other alternate embodiments, the user may select more than one location based on displayed/overlaid betting odds. In some alternate embodiments, selected locations may displayed/overlaid indicating the selection such as, but not limited to, a colored display/overlay. In some other alternate embodiments, the user may select a mix of, but not limited to, the “Who”, “What”, “When”, “Why” and “How”, choose a betting odds, view a display/overlay of locations, “Where” the chosen betting odds occur for the selected mix. As a non-limiting example, the user may choose one or more locations, “Where”, to place one or more bets. In other alternate embodiments, the user may only select a betting odds and view locations, “Where”, for available mixes of, but not limited to, the “Who”, “What”, “When”, “Why” and “How”.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

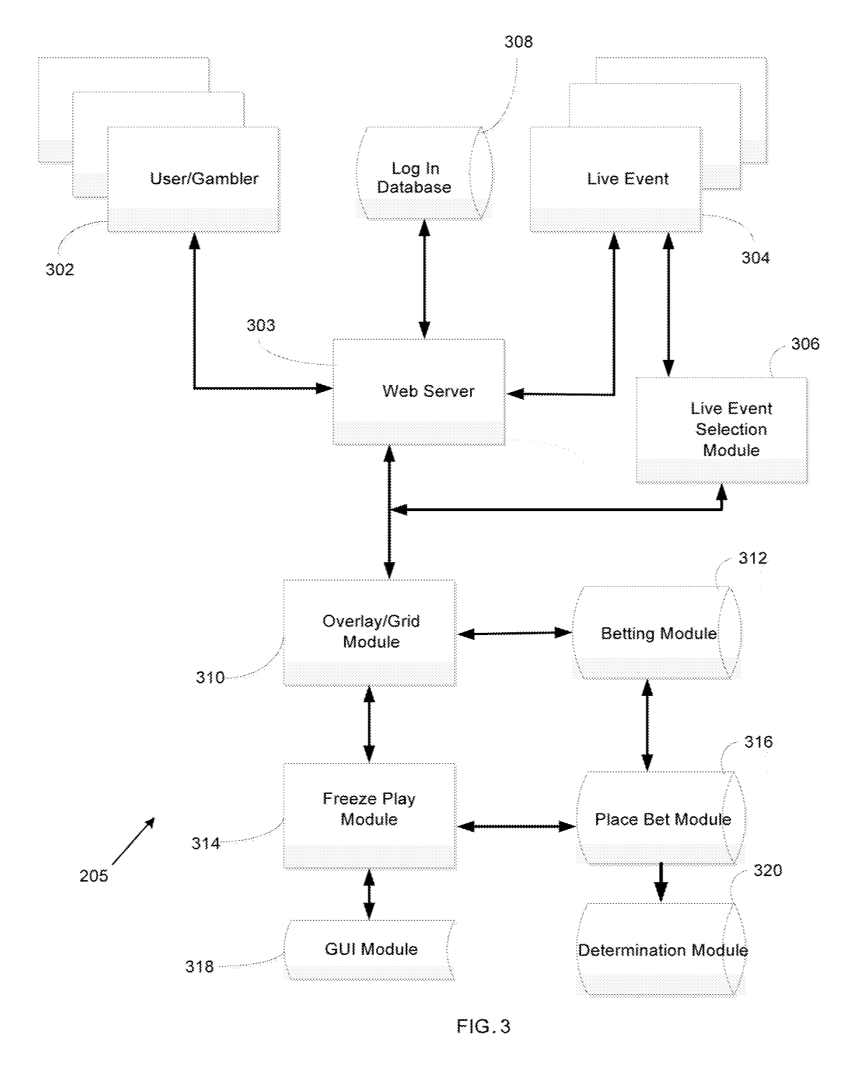

FIG. 3 illustrates an exemplary software module architecture of a system and method for placing and wagering bets, in accorance with an embodiment of the present invention.

In one embodiment, in a step 302 a user/gambler may access gambling website 205 by logging into the system at a log in database 306 to access web server 304 in order to place bets and wagers upon live events. In the present embodiment, gambling website 205 provides a live event selection module 308 by which a user/gambler 302 may select live events that are available for betting on. At a step 310, gambling website 205 may utilize an overlay/grid module to allow a user/gambler 302 to select an overlay/grid configuration that is suitable to their liking for purposes of wagering bets. At a step 312, overlay/grid database may allow user/gambler 302 to save various options and formats for overlaying various types of grids on the playing field and may also have the option of saving specific grid overlay patterns that a user/gambler prefers. Further, the use of such methods in the present embodiment of the invention, which make it possible to overlay specific grid patterns, may also enable a multiplicity of various forms of grid patterns, for example, without limitation, vertical, horizontal, sinusoidal, triangle, and square-like patterns based upon the game being played. At a step 314, betting module may allow a user/gambler 302 to place wagers on a single event or any multiplicities of events that may occur during the chosen game. Once wagers are placed on a single event or a multiplicity of events by user/gambler 302, at a step 316 betting database may save the user/gamblers betting choices and tactics, and may also be accessed to view other bets and strategies from a multiplicity of other users on the system based upon user/gambler's “like” or dislike” of the method of grid overlay and estimation of odds involved. In some embodiments, for example, without limitation, a multiplicity of databases streaming data to a server, may be accessed to identify other user/gambler betting tactics, and associated wins or losses. For example, without limitation, a user/gambler 302 may “like” a strategy of another user/gambler in which he uses a first tier normalized vertical grid combined with a second tier horizontal grid that is offset by a range of 1.5 degrees in order to wager bets for a specific player that has a particular playing style and/or movements on the field of play. Additionally, for example, without limitation, a user/gambler 302 may “dislike” a strategy of another user/gambler in which he modifies their strategy and creates his own strategy for wagering bets. For example, without limitation, if user/customer “dislikes” a first tier normalized vertical grid combined with a second tier horizontal grid that is offset by a range of 1.5 degrees, user/gambler 302 may change the initially normalized first tier vertical grid to an offset of 3.0 degrees, and normalize the second tier horizontal grid for the same player in which he chooses to wager bets upon. In some embodiments, user/gamblers may bet, or wager, or challenge each other's as to the outcome of play during a specified period of play.

In some embodiments, at a step 318 place bet module may be used to place and wager bets against other players on gambling website 205, in addition to wagering and placing bets on the outcome of events during games. At a step 320, place bet database saves and records the placement of bets. At a step 322, live games being displayed may be frozen in time at a freeze play module with overlay/grid(s) incorporated. At a step 324, user/gamblers may have the option to save freeze play data in the freeze play database for viewing later. At a step 326, freeze play module 322 may send the frozen game of play as well as overlay/grid(s) to a GUI module which may then display the frozen game of play on a visual interface such as a computer screen or a cellular phone. At a step 328, the results from freeze play module 322 and freeze play database 324 are analyzed and determined to be “accurate” or “inaccurate” at determination module. At a step 330, the determination of the outcome of the game of play may be saved and recorded at determination database. In some embodiments, if determination module 328 determines that the outcome of the game of play user/gambler wagered bets on is incorrect, user/gambler 302 may access freeze play database 324 for the saved same game of play to determine if determination module is correct or incorrect. If user/gambler 302 determines that determination module 328 is incorrect in its assessment of the outcome of the game of play, user/gambler may challenge the results within determination module 328. At a step 332, once the outcome or determination of the game of play has been verified and approved, without for example, and without limitation, a user/gambler 302 “challenge” of results, payment delivery module submits a payment to the winning user/gambler based upon the wagered bet. If user/gambler 302 wagers a bet that is incorrect, likewise user/gambler 302 must submit payment to payment delivery module 332 within a predetermined period of time which may be based upon for example, without limitation, the type of specific game being played in real time, or within a determined period after the real-time game is completed.

In some embodiments, for example, without limitation, a user/gambler may place a bet at place bet module 318 whereby the bet is 5:1 odds that player A of the New York Knicks™ will score a 3-point basket from, as a non-limiting example, grid location 10 on the court during the last 30 seconds of the second quarter of the game. Another user/gambler may see this bet in betting database 316 and determine that this event is unlikely, and decide to bet against the other user/gambler using any plausible odds, and specifying any wagered amount. When the last 30 seconds of the second quarter are played out, and player A of the New York Knicks™ doesn't make the three point shot from the specified grid location, “where”, within the wagered timeframe, determination module 328 verifies the results and directs payment delivery module 332 to send payments to user/gamblers who either won the wagered bet, or bet against another user/gambler who forecasted the wagered bet incorrectly. In some embodiments, determination database 330 may save the results of user/gambler wagered bet outcomes for viewing purposes later. In some embodiments, freeze play database 314 may also store a multiplicity of freeze framed selections for purposes of viewing material at a later time, or for challenging results of a wagered game that you bet upon.

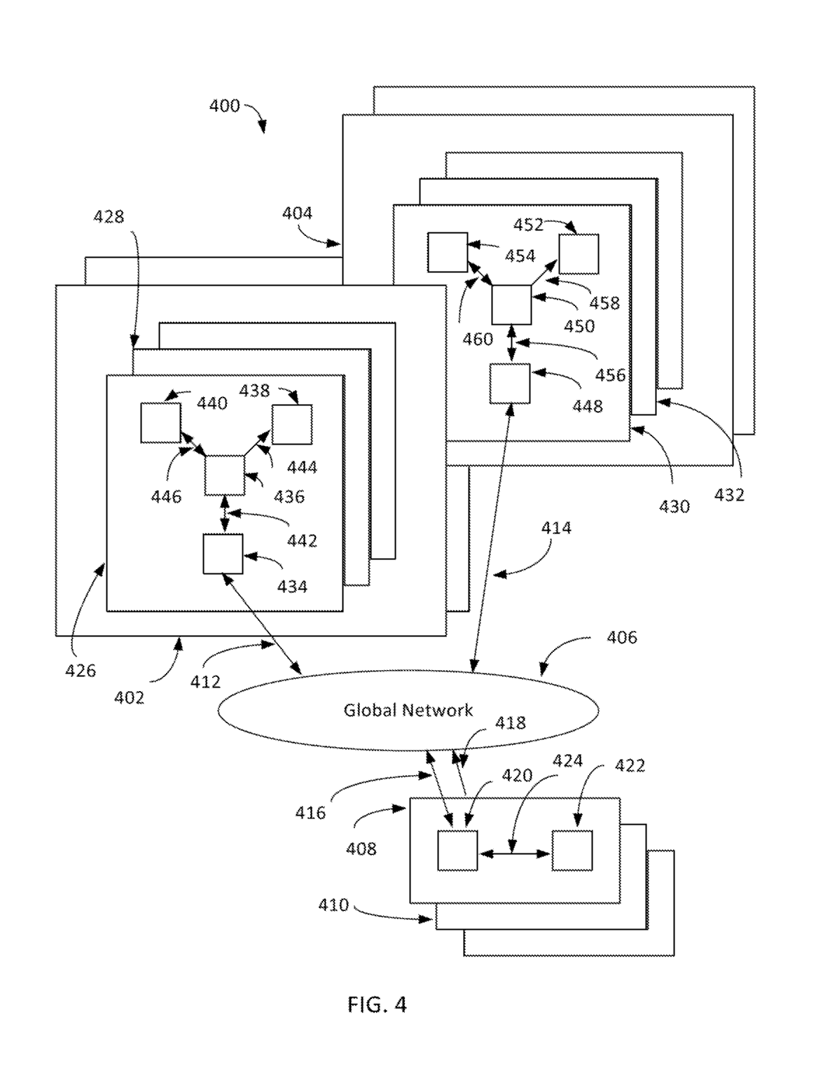

FIG. 4 illustrates a block diagram depicting a conventional client/server communication system, in accordance with an embodiment of the present invention. In some embodiments, communication system 400 includes a multiplicity of networked regions with a sampling of regions denoted as a network region 402 and a network region 405, a global network 406 and a multiplicity of servers with a sampling of servers denoted as a server device 408 and a server device 410.

In some embodiments, network region 402 and network region 405 may operate to represent a network contained within a geographical area or region. Non-limiting examples of representations for the geographical areas for the networked regions may include postal zip codes, telephone area codes, states, counties, cities and countries. Elements within network region 402 and 405 may operate to communicate with external elements within other networked regions or within elements contained within the same network region.

In some embodiments, global network 406 may operate as the Internet. It will be understood by those skilled in the art that communication system 400 may take many different forms. Non-limiting examples of forms for communication system 400 include local area networks (LANs), wide area networks (WANs), wired telephone networks, cellular telephone networks or any other network supporting data communication between respective entities via hardwired or wireless communication networks. Global network 406 may operate to transfer information between the various networked elements.

In some embodiments, server device 408 and server device 410 may operate to execute software instructions, store information, support database operations and communicate with other networked elements. Non-limiting examples of software and scripting languages which may be executed on server device 408 and server device 410 include C, C++, C# and Java.

In some embodiments, network region 402 may operate to communicate bi-directionally with global network 406 via a communication channel 412. Network region 405 may operate to communicate bi-directionally with global network 406 via a communication channel 415. Server device 408 may operate to communicate bi-directionally with global network 406 via a communication channel 416. Server device 410 may operate to communicate bi-directionally with global network 406 via a communication channel 418. Network region 402 and 405, global network 406 and server devices 408 and 410 may operate to communicate with each other and with every other networked device located within communication system 400.

In some embodiments server device 408 includes a networking device 420 and a server 422. Networking device 420 may operate to communicate bi-directionally with global network 406 via communication channel 416 and with server 422 via a communication channel 425. Server 422 may operate to execute software instructions and store information.

In some embodiments, network region 402 includes a multiplicity of clients with a sampling denoted as a client 426 and a client 428. Client 426 includes a networking device 465, a processor 466, a GUI 468 and an interface device 450. Non-limiting examples of devices for GUI 468 include monitors, televisions, cellular telephones, smartphones and PDAs (Personal Digital Assistants). Non-limiting examples of interface device 450 include pointing device, mouse, trackball, scanner and printer. Networking device 465 may communicate bi-directionally with global network 406 via communication channel 412 and with processor 466 via a communication channel 452. GUI 468 may receive information from processor 466 via a communication channel 455 for presentation to a user for viewing. Interface device 450 may operate to send control information to processor 466 and to receive information from processor 466 via a communication channel 456. Network region 405 includes a multiplicity of clients with a sampling denoted as a client 460 and a client 462. Client 460 includes a networking device 458, a processor 450, a GUI 452 and an interface device 455. Non-limiting examples of devices for GUI 468 include monitors, televisions, cellular telephones, smartphones and PDAs (Personal Digital Assistants). Non-limiting examples of interface device 450 include pointing devices, mousse, trackballs, scanners and printers. Networking device 458 may communicate bi-directionally with global network 406 via communication channel 415 and with processor 450 via a communication channel 456. GUI 452 may receive information from processor 450 via a communication channel 458 for presentation to a user for viewing. Interface device 455 may operate to send control information to processor 450 and to receive information from processor 450 via a communication channel 460.

For example, without limitation, consider the case where a user interfacing with client 426 may want to execute a networked application. A user may enter the IP (Internet Protocol) address for the networked application using interface device 450. The IP address information may be communicated to processor 466 via communication channel 456. Processor 466 may then communicate the IP address information to networking device 465 via communication channel 452. Networking device 465 may then communicate the IP address information to global network 406 via communication channel 412. Global network 406 may then communicate the IP address information to networking device 420 of server device 408 via communication channel 416. Networking device 420 may then communicate the IP address information to server 422 via communication channel 425. Server 422 may receive the IP address information and after processing the IP address information may communicate return information to networking device 420 via communication channel 425. Networking device 420 may communicate the return information to global network 406 via communication channel 416. Global network 406 may communicate the return information to networking device 465 via communication channel 412. Networking device 465 may communicate the return information to processor 466 via communication channel 452. Processor 456 may communicate the return information to GUI 458 via communication channel 455. User may then view the return information on GUI 468.

In some embodiments, location-based services platform 101 may be integrated with business intelligence solutions, and data quality providers such as, but not limited to, Cognos (IBM), Microstrategy, Information Builders, Business Objects/SAP, Teradata, Informatica, Hyperion/Oracle, SPSS, etc. Also in some embodiments, location-based services platform 101 may be integrated with other data integration/enterprise application integration solution providers such as, but not limited to, BEA/Oracle, Web Methods/Software AG, Websphere/IBM, Teradata, Informatica, Tibco and Information Builders. This enables location-based services platform 101 to leverage technology that has been developed and perfected rather than building new integration in to all of the different databases in the system. This integration allows for the system to integrate customer location information with all the other information data entities have about the customer. It creates a virtual real time “golden record” of each customer. In a non-limiting example, the system would know the products the customer has purchased, what stores the customer frequents, etc. and be able to provide true one to one marketing and information based on location while providing that information at the right and relevant time. However, in alternate embodiments new integration may be built into the databases of the system rather than using pre-existing integration solutions.

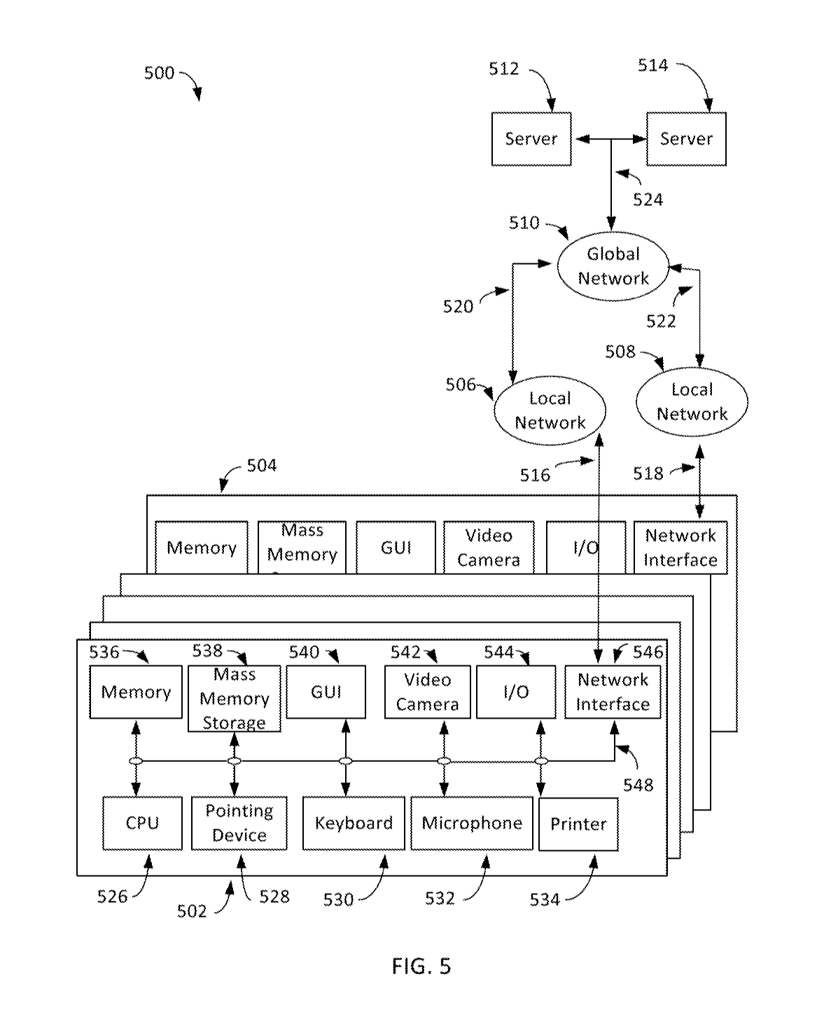

FIG. 5 illustrates a block diagram depicting a conventional client/server communication system, in accordance with an embodiment of the present invention.

In some embodiments, Communication system 500 includes a multiplicity of clients with a sampling of clients denoted as a client 502 and a client 504, a multiplicity of local networks with a sampling of networks denoted as a local network 506 and a local network 508, a global network 510 and a multiplicity of servers with a sampling of servers denoted as a server 512 and a server 514.

In some embodiments, Client 502 may communicate bi-directionally with local network 506 via a communication channel 516. Client 504 may communicate bi-directionally with local network 508 via a communication channel 518. Local network 506 may communicate bi-directionally with global network 510 via a communication channel 520. Local network 508 may communicate bi-directionally with global network 510 via a communication channel 522. Global network 510 may communicate bi-directionally with server 512 and server 514 via a communication channel 524. Server 512 and server 514 may communicate bi-directionally with each other via communication channel 524. Furthermore, clients 502, 504, local networks 506, 508, global network 510 and servers 512, 514 may each communicate bi-directionally with each other.

In some embodiments, global network 510 may operate as the Internet. It will be understood by those skilled in the art that communication system 500 may take many different forms. Non-limiting examples of forms for communication system 500 include local area networks (LANs), wide area networks (WANs), wired telephone networks, wireless networks, or any other network supporting data communication between respective entities.

In some embodiments, Clients 502 and 504 may take many different forms. Non-limiting examples of clients 502 and 504 include personal computers, personal digital assistants (PDAs), cellular phones and smartphones.

In some embodiments, Client 502 includes a CPU 526, a pointing device 528, a keyboard 560, a microphone 562, a printer 564, a memory 566, a mass memory storage 568, a GUI 540, a video camera 542, an input/output interface 544 and a network interface 546.

CPU 526, pointing device 528, keyboard 530, microphone 532, printer 534, memory 536, mass memory storage 538, GUI 540, video camera 542, input/output interface 544 and network interface 546 may communicate in a unidirectional manner or a bi-directional manner with each other via a communication channel 548. Communication channel 548 may be configured as a single communication channel or a multiplicity of communication channels.

In some embodiments, CPU 526 may be comprised of a single processor or multiple processors. CPU 526 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 536 is used typically to transfer data and instructions to CPU 526 in a bi-directional manner. Memory 536, as discussed previously, may include any suitable computer-readable media, intended for data storage, such as those described above excluding any wired or wireless transmissions unless specifically noted. Mass memory storage 538 may also be coupled bi-directionally to CPU 526 and provides additional data storage capacity and may include any of the computer-readable media described above. Mass memory storage 538 may be used to store programs, data and the like and is typically a secondary storage medium such as a hard disk. It will be appreciated that the information retained within mass memory storage 538, may, in appropriate cases, be incorporated in standard fashion as part of memory 536 as virtual memory.

In some embodiments, CPU 526 may be coupled to GUI 540. GUI 540 enables a user to view the operation of computer operating system and software. CPU 526 may be coupled to pointing device 528. Non-limiting examples of pointing device 528 include computer mouse, trackball and touchpad. Pointing device 528 enables a user with the capability to maneuver a computer cursor about the viewing area of GUI 540 and select areas or features in the viewing area of GUI 540. CPU 526 may be coupled to keyboard 530. Keyboard 530 enables a user with the capability to input alphanumeric textual information to CPU 526. CPU 526 may be coupled to microphone 532. Microphone 532 enables audio produced by a user to be recorded, processed and communicated by CPU 526. CPU 526 may be connected to printer 534. Printer 534 enables a user with the capability to print information to a sheet of paper. CPU 526 may be connected to video camera 542. Video camera 542 enables video produced or captured by user to be recorded, processed and communicated by CPU 526.

In some embodiments, CPU 526 may also be coupled to input/output interface 544 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

In yet another embodiment, CPU 526 optionally may be coupled to network interface 546 which enables communication with an external device such as a database or a computer or telecommunications or internet network using an external connection shown generally as communication channel 516, which may be implemented as a hardwired or wireless communications link using suitable conventional technologies. With such a connection, CPU 526 might receive information from the network, or might output information to a network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 65 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 65 USC §112 (6).

It is noted that according to USA law, all claims must be set forth as a coherent, cooperating set of limitations that work in functional combination to achieve a useful result as a whole. Accordingly, for any claim having functional limitations interpreted under 65 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 65 USC §112 (6) is/(are) dependent on one or more remote servers located outside the USA, it is intended that each such recited function under 65 USC §112 (6) is to be interpreted as the function of the local system receiving the remotely generated information required by a locally implemented claim limitation, wherein the structures and or steps which enable, and breathe life into the expression of such functions claimed under 65 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “65 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 65 USC §112 (1), all claims must be supported by sufficient disclosure in the present patent specification, and any material known to those skilled in the art need not be explicitly disclosed. However, 65 USC §112 (6) requires that structures corresponding to functional limitations interpreted under 65 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 65 USC §112 (6) when such corresponding structures are not explicitly disclosed in the foregoing patent specification. Therefore, for any invention element(s)/structure(s) corresponding to functional claim limitation(s), in the below claims interpreted under 65 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 65 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-872 or likewise any information disclosure statements (IDS) entered into the present patent application by the USPTO or Applicant(s) or any 6^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 65 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 65 USC §112 (6). Applicant(s) note that all the identified documents above which are incorporated by reference to satisfy 65 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing online sports betting relate to placing bets on the “Where” of a sporting event, according to the present invention will be apparent to those skilled in the art. Various aspects of the invention have been described above by way of illustration, and the specific embodiments disclosed are not intended to limit the invention to the particular forms disclosed. The particular implementation of online sports betting and placing bets on the “Where” of a sporting event may vary depending upon the particular context or application. By way of example, and not limitation, the online sports betting and placing bets on the “Where” of a sporting event described in the foregoing were principally directed to betting in freeze-framed digital grid “Where” environment implementations; however, similar techniques may instead be applied to betting, wagering, forecasting, and determining events in any suitable field of business and technology, for example, without limitation: government, military, political, economics, medical, and industry environments by which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 67 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
communicating with a computing system, said computing system at least being configured to present a sports game and accept wagers on events during said sports game;
communicating a selection of said sports game to said computing system;
receiving a play of said sports game for viewing;
receiving an overlay from said computing system, said overlay at least comprising a grid structure, said grid structure comprising a plurality of locations arranged in at least a two-dimensional space, said space at least overlaying a playing area of said sports game, wherein a single position on said overlaid playing area is identified by a one of said plurality of locations;
communicating a user's wager to said computing system, said wager at least comprising an event and a one of said plurality of locations for occurrence of said event; and
receiving an outcome of said wager from said computing system.

2. The method as recited in claim 1, in which said play of said sports game is frozen during at least said receiving said overlay and said communicating the user's wager.

3. The method as recited in claim 1, in which said space overlays said playing area in a three-dimensional space.

4. The method as recited in claim 1, in which said sporting game is live.

5. The method as recited in claim 1, in which said wager is at least in part chosen from a menu of bets.

6. The method as recited in claim 5, in which said menu of bets comprises a mixture of who, what, when, why and how associated with said event.

7. The method as recited in claim 1, in which said grid structure is selectable by the user.

8. The method as recited in claim 1, in which an overlay on said grid structure indicates a selection of a one of said plurality of locations.

9. The method as recited in claim 1, in which the user's wager further comprises a bet against another user's wager.

10. A method comprising:
steps for communicating with a computing system, said computing system at least being configured for presenting a sports game and accepting wagers on events during said sports game;
steps for communicating a selection of said sports game to said computing system;
steps for receiving a play of said sports game for viewing;
steps for receiving a grid structure of a plurality of locations overlaying a playing area of said sports game, wherein a single position on said overlaid playing area is identified by a one of said plurality of locations;
steps for communicating a user's wager to said computing system, for an event and a one of said plurality of locations for occurrence of said event; and
steps for receiving an outcome of said wager from said computing system.

11. The method as recited in claim 10, in which: said play of said sports game is frozen during at least said receiving said overlay and said communicating the user's wager; said space overlays said playing area in a three-dimensional space; in which said sporting game is live; said wager is at least in part chosen from a menu of bets; said menu of bets comprises a mixture of who, what, when, why and how associated with said event; said grid structure is selectable by the user;
an overlay on said grid structure indicates a selection of a one of said plurality of locations; and the user's wager further comprises a bet against another user's wager.

12. A non-transitory computer-readable storage medium with an executable program stored thereon, wherein the program instructs one or more processors to perform the following steps:
communicating with a computing system, said computing system at least being configured to present a sports game and accept wagers on events during said sports game;
communicating a selection of said sports game to said computing system;
receiving a play of said sports game for viewing;
receiving an overlay from said computing system, said overlay at least comprising a grid structure, said grid structure comprising a plurality of locations arranged in at least a two-dimensional space, said space at least overlaying a playing area of said sports game, wherein a single position on said overlaid playing area is identified by a one of said plurality of locations;
communicating a user's wager to said computing system, said wager at least comprising an event and a one of said plurality of locations for occurrence of said event; and
receiving an outcome of said wager from said computing system.

13. The program instructing the one or more processor as recited in claim 12, in which said play of said sports game is frozen during at least said receiving said overlay and said communicating the user's wager.

14. The program instructing the one or more processor as recited in claim 12, in which said space overlays said playing area in a three-dimensional space.

15. The program instructing the one or more processor as recited in claim 12, in which said sporting game is live.

16. The program instructing the one or more processor as recited in claim 12, in which wager is at least in part chosen from a menu of bets.

17. The program instructing the one or more processor as recited in claim 16, in which said menu of bets comprises a mixture of who, what, when, why and how associated with said event.

18. The program instructing the one or more processor as recited in claim 12, in which said grid structure is selectable by the user.

19. The program instructing the one or more processor as recited in claim 12, in which an overlay on said grid structure indicates a selection of a one of said plurality of locations.

20. The program instructing the one or more processor as recited in claim 12, in which the user's wager further comprises a bet against another user's wager.
